(19) United States
(12) Patent Application Publication
(10) Pub. No.: US 2025/0309776 A1
(43) Pub. Date: Oct. 2, 2025

(54) ALTERNATING CURRENT TO ALTERNATING CURRENT CONVERTER FOR VEHICLE-TO-LOAD ELECTRICAL POWER

(71) Applicant: GM GLOBAL TECHNOLOGY OPERATIONS LLC, DETROIT, MI (US)

(72) Inventors: Minh-Khai Nguyen, Troy, MI (US); Samantha Gunter Miller, Berkley, MI (US); Lei Hao, Troy, MI (US)

(21) Appl. No.: 18/620,114

(22) Filed: Mar. 28, 2024

(51) Int. Cl. H02M 5/293; B60L 53/22; H02J 7/02; H02M 1/00

(52) U.S. Cl. CPC H02M 5/293; B60L 53/22; H02J 7/02; H02M 1/0095; B60L 2210/20; H02J 2207/20; H02J 2310/48

(57) ABSTRACT

Examples described herein provide a circuit that includes a power electronics converter disposed in a vehicle. The power electronics converter receives alternating current (AC) electrical power from an AC grid source and provides AC electrical power to an AC load external to the vehicle. The circuit further includes an on-board charging module electrically connected to the power electronics converter and a battery disposed in the vehicle. The power electronics converter provides vehicle-to-load functionality by providing, to the AC load, AC electric power as an output of at least one of a 120 Vac output or a 240 Vac output.

The subject disclosure relates to vehicles, and in particular to an alternating current (AC) to AC converter for vehicle to load electrical power.

Modern vehicles (e.g., a car, a motorcycle, a boat, or any other type of automobile) may be equipped with one or more batteries to provide electrical power to various systems of the vehicle. For example, an electric vehicle may include one or more batteries to provide electrical power to one or more electric motors, which provide propulsion to the vehicle. This configuration of vehicle is referred to as a battery electric vehicle (BEV). Other types of vehicles may also be equipped with batteries, such as vehicles with combustion engines, hybrid-electric vehicles, and/or the like, including combinations and/or multiples thereof.

Vehicle to load (V2L) is a technique that transfers electrical power from the vehicle to an electrical load connected to the vehicle. For example, electrical power can be transferred from one or more batteries of the vehicle to a system or device connected to the vehicle that operates using the electrical power from the vehicle. This enables the vehicle to supply electrical power in various situations when electrical power may be unavailable, such as during a power outage, at a location without electrical power (e.g., a campsite, a construction site), and/or the like, including combinations and/or multiples thereof. As an example, a vehicle with V2L capabilities can be used to charge another electric vehicle. As another example, the vehicle can include one or more electrical outlets into which any suitable device can be plugged (e.g., a lamp, a coffee machine, an air compressor, and/or the like, including combinations and/or multiples thereof).

### SUMMARY

In an embodiment, a circuit is provided. The circuit includes a power electronics converter disposed in a vehicle. The power electronics converter receives alternating current (AC) electrical power from an AC grid source and provides AC electrical power to an AC load external to the vehicle. The circuit further includes an on-board charging module electrically connected to the power electronics converter and a battery disposed in the vehicle. The power electronics converter provides vehicle-to-load functionality by providing, to the AC load, AC electric power as an output of at least one of a 120 Vac output or a 240 Vac output.

In addition to one or more of the features described herein, or as an alternative, further embodiments of the circuit includes that the power electronics converter provides vehicle-to-load functionality based at least in part on an operating mode of the vehicle.

In addition to one or more of the features described herein, or as an alternative, further embodiments of the circuit include that the power electronics converter includes an AC-AC converter.

In addition to one or more of the features described herein, or as an alternative, further embodiments of the circuit include that the AC-AC converter includes a buck converter and a Ćuk converter.

In addition to one or more of the features described herein, or as an alternative, further embodiments of the circuit include that the power electronics converter includes a relay matrix.

In addition to one or more of the features described herein, or as an alternative, further embodiments of the circuit include that the power electronics converter includes an AC-AC converter and a relay matrix.

In addition to one or more of the features described herein, or as an alternative, further embodiments of the circuit include that the AC-AC converter includes a first relay and a plurality of switches and the relay matrix includes a plurality of relays.

In addition to one or more of the features described herein, or as an alternative, further embodiments of the circuit include that the first relay, the plurality of relays, and the plurality of switches are selectively enabled or disabled based on an input to the power electronics converter and based on whether the AC electric power as the 120 Vac output or the 240 Vac output.

In addition to one or more of the features described herein, or as an alternative, further embodiments of the circuit include that two of the plurality of switches are controlled to provide a high frequency pulse width modulation.

In addition to one or more of the features described herein, or as an alternative, further embodiments of the circuit include that the output is a split-phase output offering access to both 120 Vac and 240 Vac.

In another embodiment, a vehicle is provided. The vehicle includes a battery. The vehicle further includes a power electronics converter disposed in the vehicle, the power electronics converter to receive alternating current (AC) electrical power from an AC grid source and to provide AC electrical power to an AC load external to the vehicle and to the battery. The vehicle further includes an on-board charging module electrically connected to the power electronics converter and the battery disposed in the vehicle. The power electronics converter provides vehicle-to-load functionality by providing, to the AC load, AC electric power as an output of at least one of a 120 Vac output or a 240 Vac output.

In addition to one or more of the features described herein, or as an alternative, further embodiments of the vehicle include that the power electronics converter provides vehicle-to-load functionality based at least in part on an operating mode of the vehicle.

In addition to one or more of the features described herein, or as an alternative, further embodiments of the vehicle include that the power electronics converter includes an AC-AC converter.

In addition to one or more of the features described herein, or as an alternative, further embodiments of the vehicle include that the AC-AC converter includes a buck converter and a Ćuk converter.

In addition to one or more of the features described herein, or as an alternative, further embodiments of the vehicle include that the power electronics converter includes a relay matrix.

In addition to one or more of the features described herein, or as an alternative, further embodiments of the vehicle include that the power electronics converter includes an AC-AC converter and a relay matrix.

In addition to one or more of the features described herein, or as an alternative, further embodiments of the vehicle include that the AC-AC converter includes a first relay and a plurality of switches and the relay matrix includes a plurality of relays.

In addition to one or more of the features described herein, or as an alternative, further embodiments of the vehicle include that the first relay, the plurality of relays, and the plurality of switches are selectively enabled or disabled based on an input to the power electronics converter and based on whether the AC electric power as the 120 Vac output or the 240 Vac output.

In addition to one or more of the features described herein, or as an alternative, further embodiments of the vehicle include that two of the plurality of switches are controlled to provide a high frequency pulse width modulation.

In another embodiment, a method for providing vehicle-to-load functionality is provided. The method includes configuring a plurality of switches and a plurality of relays of a power electronics converter of a vehicle based on an operating mode of the vehicle. The method further includes providing vehicle-to-load functionality by directing alternating current electrical power to an alternating current (AC) load electrically connected to the vehicle based on the configuration of the plurality of switches and the plurality of relays.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a power electronics converter for providing V2L electrical power according to one or more embodiments;

FIG. 2 is a block diagram of a circuit for providing V2L electrical power according to one or more embodiments;

FIG. 3 is a block diagram of a circuit for providing V2L electrical power according to one or more embodiments; and

FIG. 4 is a block diagram of a method for providing V2L electrical power according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein provides an architecture that utilizes a power electronics converter having an alternating current (AC)-AC converter to provide 120 Vac and/or 240 Vac to a load electrically connected to a vehicle while the vehicle is charging or in motion.

The propulsion systems of electric vehicles (EVs) and plug-in hybrid electric vehicles (PHEVs) use an onboard charging module (OBCM) to charge a battery of the vehicle from the electrical grid. In such cases, the electrical grid provides AC electrical power to the vehicle. To discharge the electrical power to electrical outlets on board the vehicle, many vehicles include a standalone direct current (DC) to AC inverter, which may include similar circuitry to what would already be in an OBCM, such as filtering components, an isolation transformer, and multiple stages of power conversion. In many cases, these duplicate subcomponents, such as direct current (DC)-link capacitors or transformers, increase the complexity, size, and weight of the vehicle. This typical approach includes drawbacks, such as being relatively larger in size, being relatively heaver in weight, and/or having a relatively shorter lifetime as compared to one or more of the embodiments described herein.

One or more embodiments described herein address these and other shortcomings by providing a power electronics converter having an AC-AC converter for supplying AC electrical power to one or more devices electrically connected to a vehicle. In many cases, the proposed AC-AC converter can be used with an existing OBCM to provide V2L functionality with minimal hardware additions and controls impact to the OBCM, especially if the OBCM is already bi-directional. According to one or more embodiments, the power electronics converter with AC-AC converter, as described herein, can provide AC power at both 120 Vac and 240 Vac while the vehicle is charging using either AC electrical power or DC electrical power, while the vehicle is parked, or while the vehicle is in operation (e.g., being driven). According to one or more embodiments, the power electronics AC-AC converter, as described herein, can directly transfer electrical power from an electrical grid to both a 120 Vac load and a 240 Vac load while the vehicle is plugged into the electrical grid. One or more embodiments described herein can be implemented in a vehicle or can be used in off-vehicle applications.

According to one or more embodiments, the power electronics converter uses a single-stage non-isolated AC-AC converter that provides 120 Vac and 240 Vac electronic power. Such a device is relatively lower in cost, complexity, and size than existing approaches to V2L. According to one or more embodiments, the OBCM provides galvanic isolation between a battery of the vehicle and the external AC load (e.g., the device plugged into the vehicle). According to one or more embodiments, AC-AC power conversion can be performed directly from the grid and maintain the desired split-phase output if the input is 120 Vac or 240 Vac, where existing autotransformers are designed for one nominal input voltage, such as 240 Vac. According to one or more embodiments, the output of the power electronics AC-AC converter is a stable voltage, even when the AC grid supplying electrical power to the vehicle is disrupted or otherwise experiences a disturbance. According to one or more embodiments, the power electronics AC-AC converter can be used to supply AC electrical power to a structure, such as a house or commercial building, using vehicle-to-home (V2H) via the OBCM. One or more of the embodiments described herein can function independently without interference with the OBCM and its native functions. Other advantages are also possible.

It should be appreciated that the functioning of any vehicle implementing one or more of the embodiments described herein is improved. More particularly, by implementing the power electronics converter having a relay matrix and an AC-AC converter, as described herein, a vehicle can provide V2L functionality without the added complexity of a DC-link capacitor or transformer.

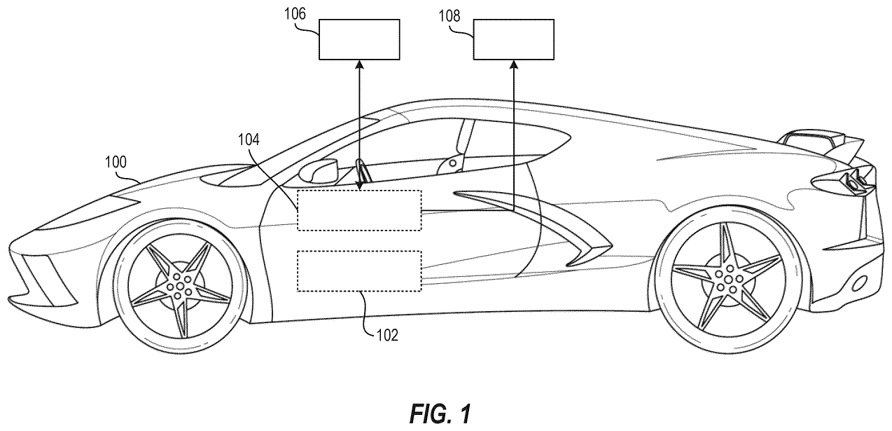

FIG. 1 is an illustration of a vehicle 100 having a power electronics converter for providing V2L electrical power according to one or more embodiments. In this example, the vehicle 100 includes a battery 102 and a power electronics converter 104. In various embodiments, the vehicle 100 includes other components, which are not shown.

The battery 102 can represent one or more batteries such that the vehicle 100 can include a single battery, multiple batteries, a battery system, and/or the like, including combinations and/or multiples thereof. The battery 102 receives electrical power (e.g., from AC grid 106, from an alternator or generator of the vehicle, and/or the like, including combinations and/or multiples thereof). According to one or more embodiments, the electrical power that is received is AC electrical power. The AC grid 106 (also referred to as an “AC grid source”) represents any suitable source of incoming electrical power. For example, the AC grid 106 can be an electrical grid designed to generate and distribute electrical power. In such cases, the vehicle 100 can be electrically connected to a charging station (not shown), which is in turn electrically connected to an electrical grid.

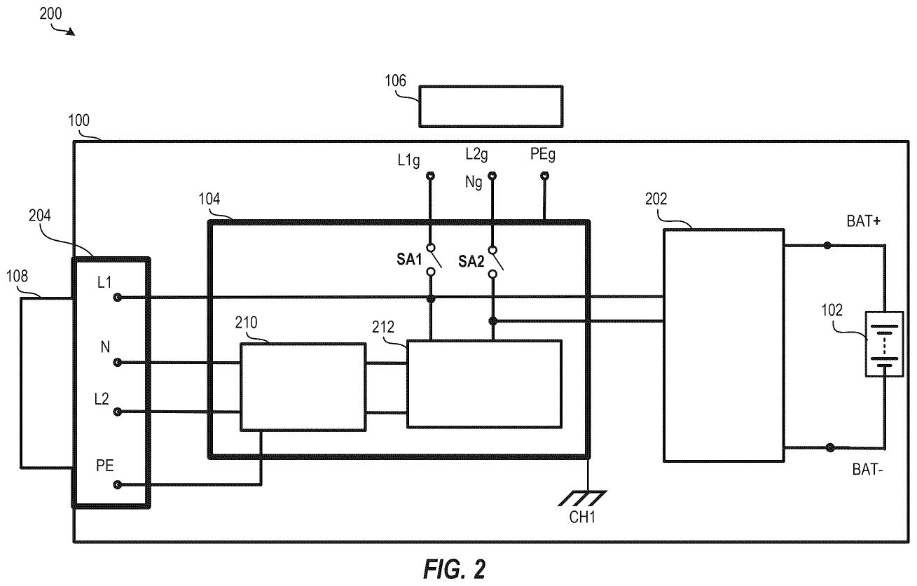

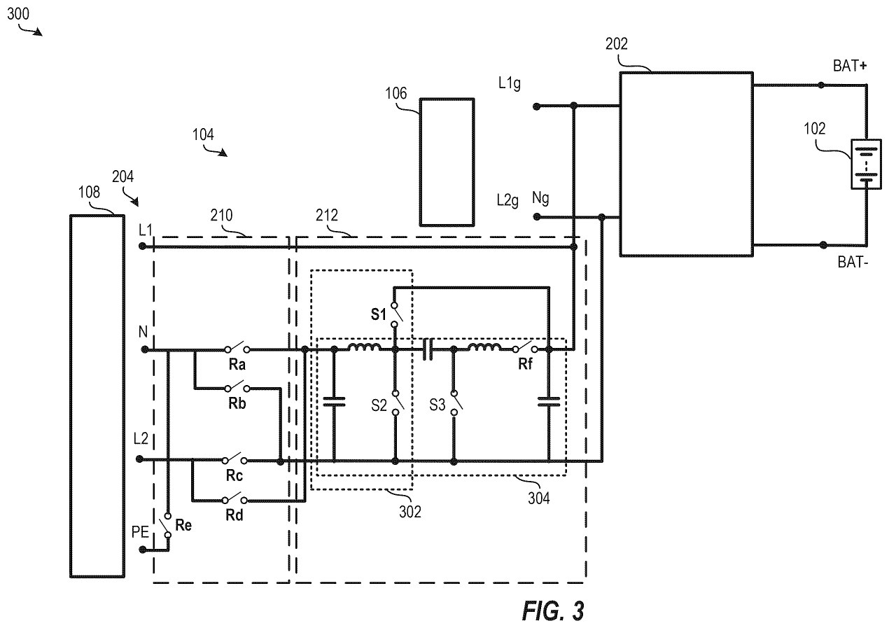

The power electronics converter 104 provides for an architecture that utilizes an AC-AC converter and relay matrix (both shown in FIGS. 2 and 3) to provide 120 Vac and/or 240 Vac to an electrical load (e.g., AC load 108) while the vehicle 100 is charging and/or while the vehicle 100 is in motion or idling. The power electronics converter 104 is an alternating current-based device in that the power electronics converter 104 receives and transmits AC electrical power.

The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power along with an internal combustion engine. According to another embodiment, the vehicle 100 is a battery electric vehicle powered by electrical power supplied by a battery. In the example of FIG. 1, the vehicle 100 includes the battery 102, which is used to supply electrical power to an electric motor (not shown) to provide propulsion to the vehicle 100, to supply electrical power to one or more internal systems of the vehicle (e.g., an infotainment system, a climate control system, and/or the like, including combinations and/or multiples thereof), and/or to supply electrical power to a system or device (e.g., the AC load 108) external to the vehicle 100. For example, a system or device (represented as the AC load 108 in FIG. 1) can be connected to the vehicle 100. In such cases, the vehicle 100 supplies electrical power to the AC load 108 using the power electronics converter 104. The electrical power can be supplied to the AC load 108 from the battery 102 and/or from the AC grid 106.

FIG. 2 is a block diagram of a circuit 200 for providing V2L electrical power according to one or more embodiments. The circuit 200 includes the battery 102, the power electronics converter 104, a bi-directional OBCM 202, and an outlet 204. The AC load 108 can electrically connect to the outlet 204. The AC grid 106 can electrically connect to the power electronics converter 104. The power electronics converter 104 includes a relay matrix 210.

The circuit 200 can support several different ways of power flow depending on the operating mode of the vehicle. For example, while the vehicle 100 is in a charging mode (e.g., while the vehicle 100 is receiving electrical power from the AC grid 106 or another suitable source, referred to as an “external charger”), electrical power flows from the AC grid 106 to the battery 102 via the OBCM 202. The OBCM 202 provides isolation between the AC grid 106 and the battery 102. As another example, when the vehicle 100 is in a V2L mode and the vehicle is receiving electrical power from the AC grid 106 or another suitable source, electrical power flows from the AC grid 106 to the AC load 108 via the AC-AC converter 212 and the relay matrix 210. In this mode, the external charger might be providing a lower power than what the AC load 108 wants to draw (e.g., 120 V portable EV chargers only provide ˜1 kW, while the AC load 108 might draw more). In this scenario, the OBCM 202 can supplement the power from the AC grid 106 by converting additional power from the battery 102. As yet another example, when the vehicle 100 is in a V2L mode and the vehicle is not receiving electrical power from the AC grid 106 or another suitable source, electrical power flows from the battery 102 to the AC load 108 via the OBCM 202, the AC-AC converter 212, and the relay matrix 210. This situation may include where DC-based fast charging is being performed or while the vehicle 100 is parked or in motion. As yet another example, when the vehicle 100 is in the AC charging mode (e.g., while the vehicle 100 is receiving electrical power from the AC grid 106 or another suitable source), electrical power flows from the AC grid 106 to the battery 102 via the OBCM 202 and from the AC grid 106 to the AC load 108 via the AC-AC converter 212 and the relay matrix 210. In this situation, total power from the AC grid 106 should not exceed a limit of the external charger, so the vehicle 100 can ensure that the total power going to the AC load 108 plus the total power going to the battery 102 is within the limit of the external charger. As yet another example, when the vehicle 100 is operating in a vehicle-to-vehicle (V2V) mode (e.g., the vehicle 100 is providing AC electrical power to another vehicle (not shown)), electrical power flows from the battery 102 to the other vehicle via the OBCM 202 and a charge port (not shown) to which an external charger can connect and/or from the battery 102 to the other vehicle via the OBCM 202, the AC-AC converter 212, the relay matrix 210, and the outlet 204.

The relay matrix 210 includes relays that can be selectively enabled (e.g., closed) and disabled (e.g., opened) according to a desired mode of operation of the circuit 200. The relays of the relay matrix 210 can be selectively enabled/disabled based on a voltage of the AC grid 106, for example. According to one or more embodiments, the relay matrix 210 determines the neutral connection based on the voltage of the AC grid 106. The relay matrix 210 is shown in more detail in FIG. 3 and is described further herein.

The power electronics converter 104 also includes an AC-AC converter 212. The AC-AC converter 212 includes various components for providing a split-phase output, such as 120 Vac electrical power and 240 Vac electrical power, which are shown in more detail in FIG. 3 and are described further herein. It should be appreciated that the AC-AC converter 212 can be any suitable type of converter or combination of converters that provide the appropriate voltage magnitude and phase for each output. For example, the AC-AC converter 212 can be a buck converter, a boost converter, a buck-boost converter, a Ćuk converter, and/or the like, including combinations and/or multiples thereof.

Referring to FIG. 2, AC electrical power is provided to the vehicle 100 by the AC grid 106 at L1g, L2g/Ng, and PEg (collectively referred to as the “charge port”) as shown, where PEg refers to the protective earth of the AC grid 106. In particular, the AC grid 106 can be connected to the power electronics converter 104, which distributes the electrical power to one or more of the battery 102 via the OBCM 202 and/or to the AC load 108 via the AC-AC converter 212 and relay matrix 210 as shown. Two switches, SA1 and SA2, can selectively enable and disable the connection between the AC grid 106 and the AC-AC converter 212 and the OBCM 202 based on what is plugged in at the charge port (e.g., at L1g, L2g/Ng, and PEg). For example, if the AC grid 106 is plugged into the charge port, the switches SA1 and SA2 are enabled (e.g., closed). In some cases, it is desirable to disable (e.g., open) one or more of the switches SA1 and SA2, such as if the vehicle 100 is performing DC-DC fast charging or if nothing is connected to the charge port. Two switches are provided for redundancy, which may reduce the likelihood of failure in the event one of the switches becomes stuck/welded closed; however, in other embodiments, the number of switches can be reduced and/or the switches can be eliminated entirely. To ensure each switch SA1 and SA2 is in the intended state (e.g., open or closed), there can be accompanying sensing circuitry and diagnostic control according to one or more embodiments.

The AC load 108 connects to the outlet 204 at L1, N, L2, and PE as shown. In one embodiment, L1 is connected directly to the OBCM 202, and N, L2, and PE (protective earth) are connected to the relay matrix 210 as shown. According to one or more embodiments, L1 and N can together provide 120 Vac to the AC load 108 while L2 and N can together provide 120 Vac to another AC load (not shown). In this case, the two 120 Vac supplies to the AC loads are out of phase relative to one another (e.g., the 120 Vac supplied by L2/N is out of phase relative to the 120 Vac supplied by L1/N), thereby providing 240 Vac by L1/L2.

Different scenarios for providing AC electrical power to the AC load 108 are now described with reference to FIG. 3, which also shows more detail of aspects of the power electronics converter 104. In particular, FIG. 3 is a block diagram of a circuit 300 for providing V2L electrical power according to one or more embodiments. In the example of FIG. 3, the relay matrix 210 and the AC-AC converter 212 of the power electronics converter 104 are shown in more detail.

The relay matrix 210 includes five relays configured and arranged as shown, including relays Ra, Rb, Rc, Rd, and Re. The relays Ra-Re can be selectively enabled (e.g., closed) and disabled (e.g., opened) depending on different scenarios, which are described herein. To ensure each relay Ra-Re is in the intended state (e.g., open or closed), there can be accompanying sensing circuitry and diagnostic control according to one or more embodiments.

The AC-AC converter 212 includes a buck converter 302 and a Ćuk converter 304, which together provide split-phase 120 Vac. The buck converter 302 includes switches S1 and S2, among other components (e.g., a capacitor and an inductor). The Ćuk converter 304 includes relay Rf and switches S2 and S3, among other components (e.g., capacitors and inductors as shown). Together, the buck converter 302 and the Ćuk converter 304 enable the AC-AC converter 212 to provide split-phase 120 Vac and/or 240 Vac to the AC load 108.

As described above, the relays Ra-Re of the relay matrix 210 and the switches S1-S3 and relay Rf of the AC-AC converter 212 can be configured differently depending on different scenarios, which are now described. In a first scenario, the vehicle 100 is connected to AC grid 106 at L1g and L2g/Ng as shown in FIGS. 2 and 3 and is receiving 120 Vac. In this scenario, relays Rb, Rd, and Rf of the power electronics converter 104 are enabled (e.g., closed), and the relays Ra and Rc are disabled (e.g., open); switch S1 is disabled (e.g., open), and the switches S2 and S3 are controlled in high frequency pulse width modulation (PWM) to achieve the Ćuk converter 304 function. As a result of this configuration of relays and switches, the output of the Ćuk converter 304 across L2/N is 120 Vac and out-of-phase with L1/N at the outlet 204.

In a second scenario, the vehicle 100 is connected to AC grid 106 at L1g and L2g/Ng as shown in FIGS. 2 and 3 and is receiving 240 Vac. In this scenario, the relays Ra and Rc are enabled (e.g., closed), and the relays Rb, Rd, and Rf are disabled (e.g., open); switch S3 is disabled (e.g., open), and the switches S1 and S2 are controlled in high frequency PWM to achieve the buck converter 302 function. As a result of this configuration of relays and switches, the output of the buck converter 302 is reduced from 240 Vac (e.g., from the AC grid 106) to 120 Vac across L2/N at the outlet 204. 240 Vac is still maintained across L1/L2 and 120 Vac is created across L1/N, thereby providing the desired split-phase output at the outlet 204.

In a third scenario, the vehicle 100 is not connected to AC grid 106 in what is referred to as an “off-grid” scenario. In this scenario, the OBCM 202 discharges the battery 102 at 240 Vac. The relays Ra and Rc are enabled (e.g., closed), and the relays Rb, Rd, and Rf are disabled (e.g., open); switch S3 is disabled (e.g., open), and the switches S1 and S2 are controlled in high frequency PWM to achieve the buck converter 302 function. As a result of this configuration of relays and switches, the output of the buck converter 302 is reduced from 240 Vac (e.g., from the OBCM 202) to 120 Vac across L2/N at the outlet 204. 240 Vac is still maintained across L1/L2 and 120 Vac is created across L1/N, thereby providing the desired split-phase output at the outlet 204.

According to an embodiment, the relatively high frequency PWM may be 100-250 kHz, although other frequencies may be used in other embodiments. The switches S1-S3 can be bi-directional switches with insulated-gate bipolar transistors (IGBT), metal-oxide-semiconductor field-effect transistor (MOSFET) based on silicon (Si), silicon carbide (SiC), and/or gallium nitride (GaN), and/or the like, including combinations and/or multiples thereof.

According to one or more embodiments, the relay Re of the relay matrix 210 can be selectively enabled (e.g., closed) and disabled (e.g., open) depending on the situation in which the vehicle 100 is providing the electrical power. For example, the relay Re is closed for V2L to power plug-and-cord connected loads, similar to a bonded neutral generator. As another example, the relay Re is open for V2H to power a house or other similar structure, similar to a floating neutral generator.

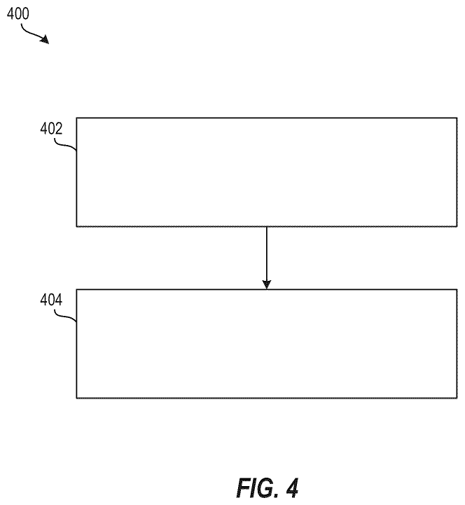

FIG. 4 is a block diagram of a method 400 for providing V2L electrical power according to one or more embodiments. The method 400 can be performed by any suitable device, such as the power electronics converter 104 of FIGS. 1-3.

At block 402, the power electronics converter 104 configures a plurality of switches (e.g., the switches S1-S3) and a plurality of relays (e.g., the relays Ra-Rf) based on an operating mode of the vehicle 100. As described herein, various operating modes are possible, such as a charging mode (plugged into AC grid 106), V2L mode while unplugged from AC grid 106, V2L mode while plugged into AC grid 106, V2L mode while charging, V2V mode, and/or the like, including combinations and/or multiples thereof. Different switch and relay configurations are possible depending on the operating mode of the vehicle and are described in more detail herein.

At block 404, the power electronics converter 104 provides V2L functionality by directing AC electrical power to the AC load 108 based on the configuration of the plurality of switches and the plurality of relays. The AC electrical power can be 120 Vac and/or 240 Vac. For example, the AC electrical power to the battery 102 can be 240 Vac, and the AC electrical power to the AC load 108 can be split-phase 120 Vac and/or 240 Vac.

Additional processes also may be included, and it should be understood that the processes depicted in FIG. 4 represent illustrations, and that other processes may be added or existing processes may be removed, modified, or rearranged without departing from the scope of the present disclosure.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A circuit comprising:
a power electronics converter disposed in a vehicle, the power electronics converter to receive alternating current (AC) electrical power from an AC grid source and to provide AC electrical power to an AC load external to the vehicle; and
an on-board charging module electrically connected to the power electronics converter and a battery disposed in the vehicle,
wherein the power electronics converter provides vehicle-to-load functionality by providing, to the AC load, AC electric power as an output of at least one of a 120 Vac output or a 240 Vac output.

2. The circuit of claim 1, wherein the power electronics converter provides vehicle-to-load functionality based at least in part on an operating mode of the vehicle.

3. The circuit of claim 1, wherein the power electronics converter comprises an AC-AC converter.

4. The circuit of claim 3, wherein the AC-AC converter comprises a buck converter and a Ćuk converter.

5. The circuit of claim 1, wherein the power electronics converter comprises a relay matrix.

6. The circuit of claim 1, wherein the power electronics converter comprises an AC-AC converter and a relay matrix.

7. The circuit of claim 6, wherein the AC-AC converter comprises a first relay and a plurality of switches and the relay matrix comprises a plurality of relays.

8. The circuit of claim 7, wherein the first relay, the plurality of relays, and the plurality of switches are selectively enabled or disabled based on an input to the power electronics converter and based on whether the AC electric power as the 120 Vac output or the 240 Vac output.

9. The circuit of claim 7, wherein two of the plurality of switches are controlled to provide a high frequency pulse width modulation.

10. The circuit of claim 1, wherein the output is a split-phase output offering access to both 120 Vac and 240 Vac.

11. A vehicle comprising:
a battery;
a power electronics converter disposed in the vehicle, the power electronics converter to receive alternating current (AC) electrical power from an AC grid source and to provide AC electrical power to an AC load external to the vehicle and to the battery; and
an on-board charging module electrically connected to the power electronics converter and the battery disposed in the vehicle,
wherein the power electronics converter provides vehicle-to-load functionality by providing, to the AC load, AC electric power as an output of at least one of a 120 Vac output or a 240 Vac output.

12. The vehicle of claim 11, wherein the power electronics converter provides vehicle-to-load functionality based at least in part on an operating mode of the vehicle.

13. The vehicle of claim 11, wherein the power electronics converter comprises an AC-AC converter.

14. The vehicle of claim 13, wherein the AC-AC converter comprises a buck converter and a Ćuk converter.

15. The vehicle of claim 11, wherein the power electronics converter comprises a relay matrix.

16. The vehicle of claim 11, wherein the power electronics converter comprises an AC-AC converter and a relay matrix.

17. The vehicle of claim 16, wherein the AC-AC converter comprises a first relay and a plurality of switches and the relay matrix comprises a plurality of relays.

18. The vehicle of claim 17, wherein the first relay, the plurality of relays, and the plurality of switches are selectively enabled or disabled based on an input to the power electronics converter and based on whether the AC electric power as the 120 Vac output or the 240 Vac output.

19. The vehicle of claim 17, wherein two of the plurality of switches are controlled to provide a high frequency pulse width modulation.

20. A method for providing vehicle-to-load functionality, the method comprising:
configuring a plurality of switches and a plurality of relays of a power electronics converter of a vehicle based on an operating mode of the vehicle; and
providing vehicle-to-load functionality by directing alternating current (AC) electrical power to an AC load electrically connected to the vehicle based on the configuration of the plurality of switches and the plurality of relays,
wherein the power electronics converter comprises an AC-AC converter and a relay matrix, the AC-AC converter comprising a first relay and a plurality of switches, the relay matrix comprising a plurality of relays, and
wherein the first relay, the plurality of relays, and the plurality of switches are selectively enabled or disabled based on an input to the power electronics converter and based on whether the AC electric power is a 120 Vac output or a 240 Vac output.
